(19) United States
(12) Patent Application Publication
(10) Pub. No.: US 2019/0106197 A1
(43) Pub. Date: Apr. 11, 2019

(54) Variable-Chord Rotor Blade

(71) Applicant: Bell Helicopter Textron Inc., Fort Worth, TX (US)

(72) Inventors: Christopher Edward Foskey, Keller, TX (US); Jared Mark Paulson, Fort Worth, TX (US); Michael Christopher Burnett, Fort Worth, TX (US)

(73) Assignee: Bell Helicopter Textron Inc., Fort Worth, TX (US)

(21) Appl. No.: 15/728,386

(22) Filed: Oct. 9, 2017

(51) Int. Cl. B64C 11/20; B64C 29/00

(52) U.S. Cl. CPC B64C 11/20; B64C 29/0033

(57) ABSTRACT

A blade for an aircraft rotor has a trailing-edge tab, the tab being movable between a stowed position, in which substantially all of the tab is located within the blade, and a deployed position, in which at least a portion of the tab extends from a trailing edge of the blade. At least one actuator system is selectively operable to cause movement of the tab between the stowed position and the deployed position for changing a chord length of the blade.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Tiltrotor aircraft are generally operable in a helicopter flight mode to hover and/or ascend from and descend to a landing area and in an airplane flight mode to propel the aircraft forward. The transition from the rotor-borne helicopter flight mode to the wing-borne airplane flight mode, and vice versa, is generally accomplished by selectively rotating engine nacelles and/or rotor pylons of the aircraft forward and/or backward to change the thrust angle of the rotors. Maximizing performance of such rotatable aircraft rotors to maximize the performance of the aircraft in one flight mode may often require performance tradeoffs that reduce and/or alter the performance of the aircraft in the other mode.

### BRIEF DESCRIPTION OF THE DRAWINGS

FIG. 1A is an oblique side view of an aircraft rotor blade having a deployable trailing-edge tab according to an embodiment of the disclosure and shown in the stowed position.

FIG. 1B is an oblique side view of the aircraft blade of FIG. 1A and showing the trailing-edge tab in the deployed position.

FIG. 2A is a top view of the aircraft blade of FIG. 1A and showing the trailing-edge tab in the stowed position.

FIG. 2B is a top view of the aircraft blade of FIG. 1A and showing the trailing-edge tab in the deployed position.

FIG. 3 is a partial cross-sectional view of the aircraft blade of FIG. 1A taken along cutting line 3-3 of FIG. 2A and showing the trailing-edge tab in the stowed position.

FIG. 4 a partial oblique top view of the aircraft blade of FIG. 1A showing a plurality of actuator systems according to an embodiment of the disclosure.

FIG. 5 is a detailed top view of an actuator system of FIG. 4 shown in the stowed position.

FIG. 6 is detailed top view of the actuator system of FIG. 4 shown in the deployed position.

FIG. 7 is a partial side cross-sectional view of another embodiment of an aircraft rotor blade according to the disclosure and taken along a cutting line similar to 3-3 of FIG. 2A.

FIG. 8 is a top view of a flat pattern of a structural ply for the aircraft blade of FIG. 8.

FIG. 9 is a top view of a portion of the aircraft blade of FIG. 8.

FIG. 10 is a top view of an aircraft rotor blade according to another embodiment of the disclosure.

FIG. 11 is a top view of a tiltrotor aircraft according to an embodiment of the disclosure and configured for operation in the airplane flight mode, trailing-edge tabs being shown in a stowed position.

FIG. 12 is a top view of the tiltrotor aircraft of FIG. 8 configured for operation in the helicopter flight mode, trailing-edge tabs being shown in a deployed position.

FIG. 13 is a flowchart of a method of operating an aircraft according to an embodiment of the disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure divulges a variable-chord rotor blade having a deployable trailing-edge tab. The tab provides increased rotor solidity when in the deployed position, which is preferably used in a helicopter flight mode, whereas the stowed position reduces rotor solidity and aerodynamic drag on the blade and is preferably used in an airplane flight mode.

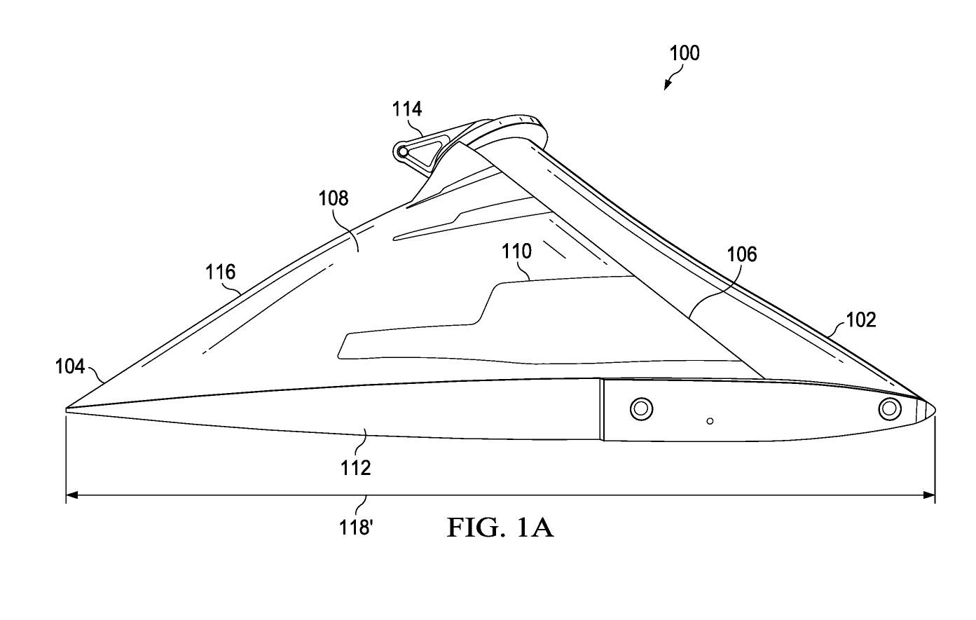

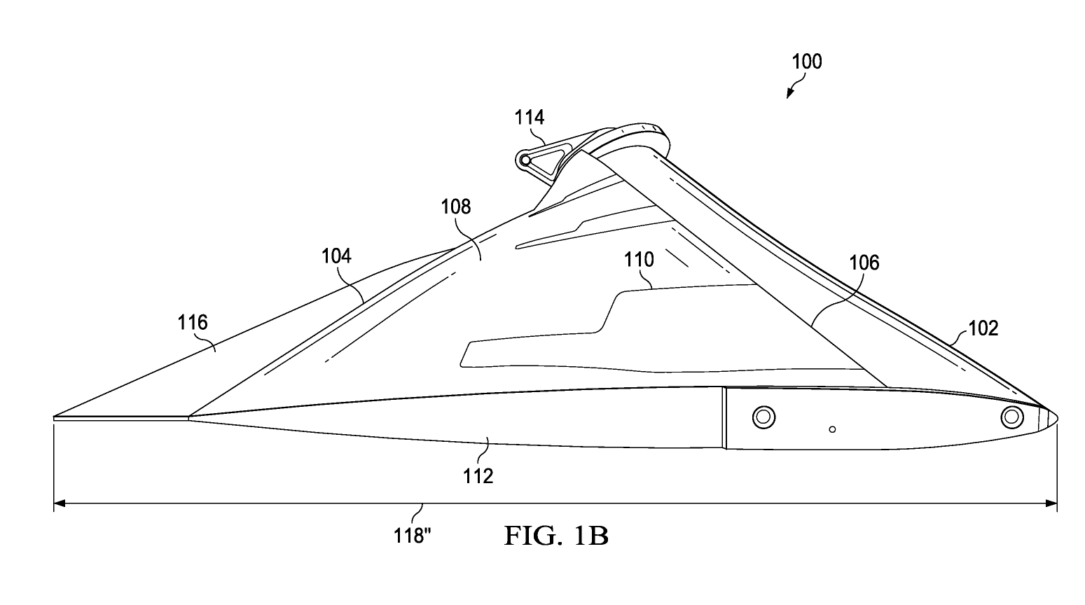

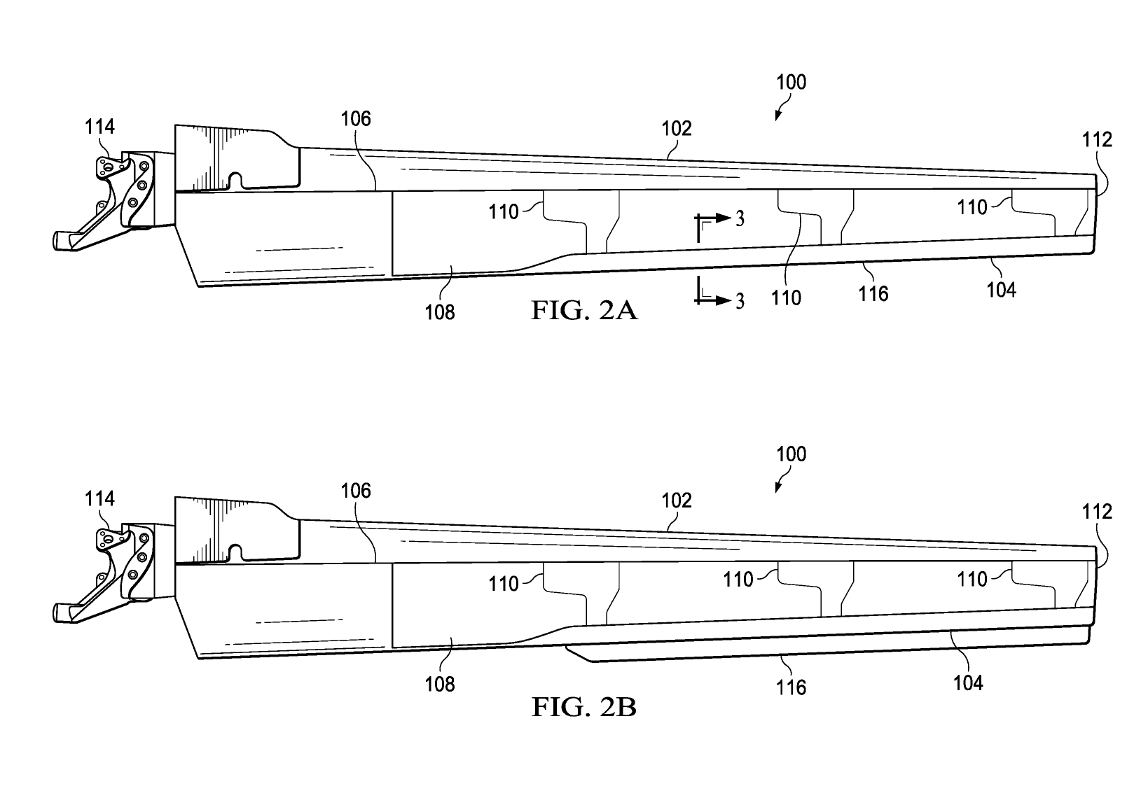

Referring now to FIGS. 1A-2B, an aircraft blade 100 is shown according to an embodiment of the disclosure. Aircraft blade 100 may generally be used in an aircraft that is operable in an airplane flight mode (hereinafter “airplane mode”) associated with propelling the aircraft forward and a helicopter flight mode (hereinafter “helicopter mode”) associated with hovering and/or ascending from and descending to a landing area.

Aircraft blade 100 generally comprises a leading edge 102, a trailing edge 104, a spar 106 extending along a length of blade 100 and configured to provide integral support to the structure of blade 100, a blade afterbody 108, a plurality of tub panels 110 that cover actuators (described below) carried in composite tubs, a blade tip 112 associated with a distal outer end of blade 100, and a mounting mechanism 114 for securing blade 100 to a rotor hub (not shown) of an aircraft.

Additionally, blade 100 also comprises a deployable trailing-edge tab 116. Tab 116 may generally be received within trailing edge 104 of blade 100 and selectively deployable to adjust a chord length 118 of blade 100. FIGS. 1A and 2A show tab 116 in a fully stowed position, while FIGS. 1B and 2B show tab 116 in a fully deployed position, though it should be noted that tab 116 may be deployed to any intermediate position between those shown. Chord length 118 may generally be defined as the distance between leading edge 102 and trailing edge 104 of blade 100. In the embodiment shown, tab 116 comprises a substantially uniform thickness and width across tab 116, though in other embodiments tab 116 may vary in thickness and/or width. For example, in some embodiments, tab 116 may comprise a chamfered profile on an innermost edge of tab 116 or may comprise a straight, rounded, and or other profile shape on the innermost edge of tab 116. In some embodiments, tab 116 may generally be formed from titanium and in other embodiments formed from aluminum, a composite material (e.g. carbon- or glass-fiber reinforced plastic, etc.), and/or any other lightweight, high-strength material. Furthermore, tab 116 may comprise a fixed pitch and extend linearly from trailing edge 104. However, tab 116 may remain flexible when deployed, such that tab 116 may flex with the remainder of blade 100.

Tab 116 may generally extend lengthwise along trailing edge 104 of blade 100 from blade tip 112 and/or a location substantially adjacent blade tip 112. In the embodiment shown, tab 116 extends along trailing edge 104 for approximately 50% of the span and/or length of blade 100. However, in other embodiments, tab 116 may extend along a smaller or larger percentage of the length of blade 100, up to and including 100% of the length of blade 100. As shown, tab 116 may extend along and/or parallel to the chord line of blade 100. In other embodiments, tab 116 may be deflected a few degrees downward relative to the chord line to more closely align with the camber line of blade 100 and improve lift characteristics. Tab 116 is configured to flex together with blade 100 during out-of-plane flapping motions of blade 100.

In operation, blade 100 may generally be employed in an aircraft that is operable in both airplane mode and helicopter mode, and tab 116 of aircraft blade 100 may generally be selectively deployable to adjust a chord length 118 of blade 100 to optimize aircraft performance in each of these flight modes. When the aircraft is operated in airplane mode, tab 116 is preferably retracted to the stowed position within trailing edge 104, as shown in FIGS. 1A and 2A, to provide aircraft blade 100 with a shorter chord length 118′. It will be appreciated that tab 116 may generally be concealed within and/or fit within a footprint of blade 100 as viewed from the top of blade 100, as shown in FIG. 2A, when tab 116 is in the stowed position. However, in some embodiments, tab 116 may extend at least partially from trailing edge 104 to maintain a streamlined and/or substantially pointed trailing edge 104.

During typical operation, tab 116 will remain stowed when the aircraft is operating in airplane mode, and tab 116 will remain deployed when the aircraft is operating in helicopter mode. However, as will be described later herein in more detail, as the nacelles and/or rotatable pylons of an aircraft are rotated, tab 116 may be selectively gradually stowed and/or deployed as the aircraft transitions between operational modes, and gradual movement of tab 116 may prevent abrupt changes in operational and/or performance characteristics.

Deploying tab 116 to the deployed position when blade 100 is operated, as shown in FIGS. 1B and 2B, increases “rotor solidity,” defined as the ratio of total blade area to overall rotor disk area, and this provides increased thrust of blade 100 due to the longer chord length 118″. This increase of thrust is especially desirable while operating in helicopter mode, providing greater hover capacity and increasing the performance envelope. Higher thrust may allow for increased payload capacity, or may allow completion of a mission involving, for example, hovering and/or landing at high-altitude locations and/or in high ambient temperatures. However, deployed tabs 116 cause higher aerodynamic drag on each blade 100, and retracting tab 116 to the stowed position when blade 100 is operated reduces rotor solidity and aerodynamic profile drag on blade 100 due to the shorter chord length 118′ of blade 100, as compared to when tab 116 is in the deployed position. This decrease of profile drag is more significant and desirable during operation in airplane mode.

Tab 116 will preferably be designed to minimize weight added to blade 100 while optimizing performance characteristics. In an example, a version of tab 116 that provides a longer chord length 118″ by a few inches over the shorter chord length 118′ may increase hover capacity of a particular aircraft configuration by a few thousand pounds. Further, by retracting tab 116 within trailing edge 104 of blade 100 to provide the shorter chord length 118′, a reduction in drag on blade 100 of a few percent may be achieved as compared to the drag on blade 100 when tab 116 is deployed. Thus, selectively transitioning tab 116 to adjust chord length 118 in flight can optimize performance in both airplane mode and helicopter mode and in transition regimes.

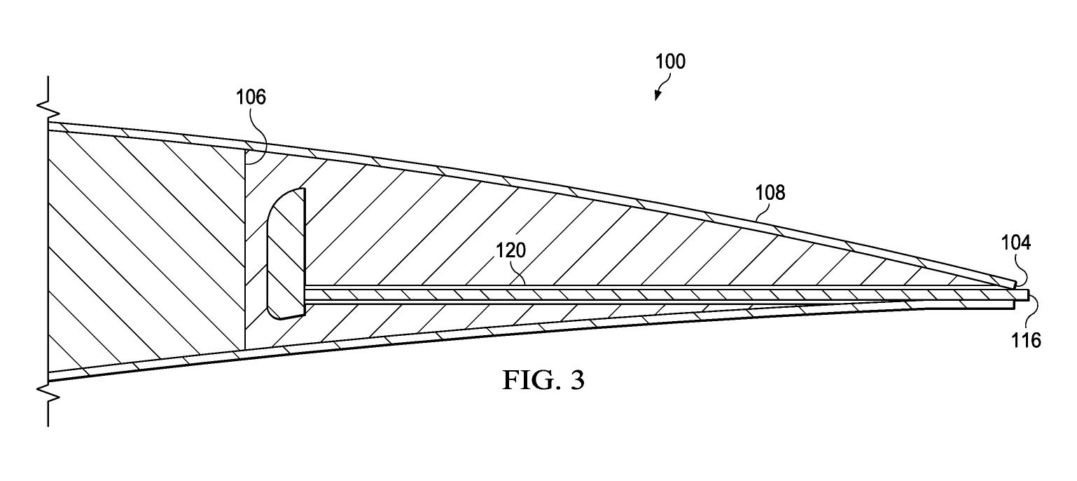

Referring now to FIG. 3, a portion of blade 100 is shown in a partial cross-sectional view taken along cutting line 3-3 of FIG. 2A. As shown, blade 100 comprises a tab channel 120 extending forward from trailing edge 104 and at least partially through afterbody 108. In some embodiments, tab channel 120 may generally be formed from multiple composite layers. However, in other embodiments, tab channel 120 may be formed from aluminum, titanium, and/or any rigid material. Tab channel 120 is configured to receive substantially all of tab 116 when tab 116 is in the stowed position. Also, in some embodiments, at least a portion of tab 116 may remain within tab channel 120 when tab 116 is in the deployed position. Tab channel 120 may also be configured to receive tab 116 linearly within tab channel 120 and restrict vertical motion of at least a portion of tab 116 located within tab channel 120 when tab 116 is in the stowed and/or the deployed position. Accordingly, at least in some embodiments, tab channel 120 may provide additional strength and/or structural integrity to tab 116 and/or trailing edge 104 of blade 100. Furthermore, in some embodiments, blade 100 may further comprise structural components that maintain a position of trailing edge 104 and/or the width of tab channel 120 to avoid separation between opposing sides of tab channel 120 and trailing edge 104.

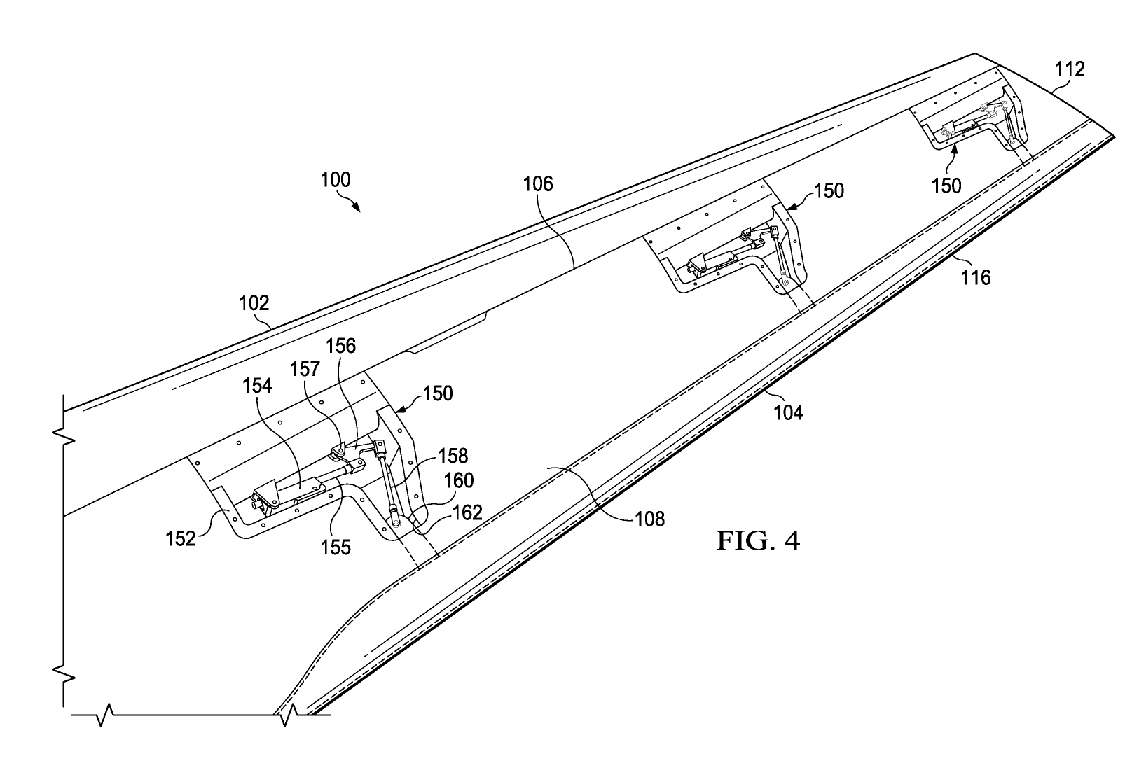

Referring now to FIG. 4, a partial oblique top view of blade 100 illustrates a plurality of actuator systems 150 according to an embodiment of the disclosure and installed within blade 100. Blade 100 is shown with tub panels 110 removed to expose actuator systems 150. Further, while three actuator systems 150 are shown, blade 100 may comprise any number (e.g. 1, 2, 3, etc.) of actuator systems 150 depending on the application and/or the aircraft. Each actuator system 150 comprises a tub 152 for housing movable components of actuator system 150, an actuator 154, a pivotable lever 156, a drive link 158, and a tab tongue 160 coupled to tab 116. Tub 152 may generally comprise a composite tub that may be secured to, attached to, fastened to, bonded to and/or integrally formed with spar 106 and/or a portion of afterbody 108 of blade 100 to maintain the structural integrity and structure of afterbody 108 while providing space for the movable components of actuator system 150 to articulate. Further, tub 152 permits adjustability of chord length 118 during flight of the aircraft while retaining the structure of blade 100.

Actuator 154 is preferably an electromagnetic linear motor having an actuator shaft 155 extending therefrom. However, in other embodiments, actuator 154 may comprise a hydraulic actuator and/or other type of linear or rotary actuator. Actuator 154 may generally be mounted to a trailing portion of spar 106 and/or a portion of tub 152 that is secured to spar 106. Actuator 154 is coupled to lever 156 and configured to rotate lever 156 about a pivot point 157 also secured to a trailing portion of spar 106 and/or a portion of tub 152 that is secured to spar 106. By securing actuator 154 and lever 156 to spar 106 and/or a portion of tub 152 secured to spar 106, the weight of actuator system 150 may be disposed as close to the front quarter chord of blade 100 as possible, thereby maintaining substantially optimum weight distribution through blade 100. However, additional weight in blade afterbody 108 may be offset by adding counterweight to or near leading edge 102. The additional mass added to blade 100 by actuator systems 150 and associated structures is mitigated by a reduction in the mass of tip and/or midspan weights needed for 1^{st} in-plane frequency tuning of blade 100.

Lever 156 is rotatably coupled to drive link 158, and each may be formed from aluminum, titanium, and/or any other material providing a high strength-to-weight ratio. Rotation of lever 156 about pivot point 157 generally drives drive link 158 either toward or away from trailing edge 104 of blade 100. Drive link 158 is coupled to a tab tongue 160, which is generally formed from a composite material and integrally formed with tab 116 for attachment to drive link 158. However, in other embodiments, tab tongue 160 may be formed from aluminum, titanium, and/or any other high strength-to-weight material and be secured, attached, fastened, bonded or otherwise coupled to tab 116. Tab tongue 160 is configured to linearly slide through a guide 162 formed in tub 152 and/or at least a portion of afterbody 108 to linearly transition tab 116 between the stowed position and the deployed position.

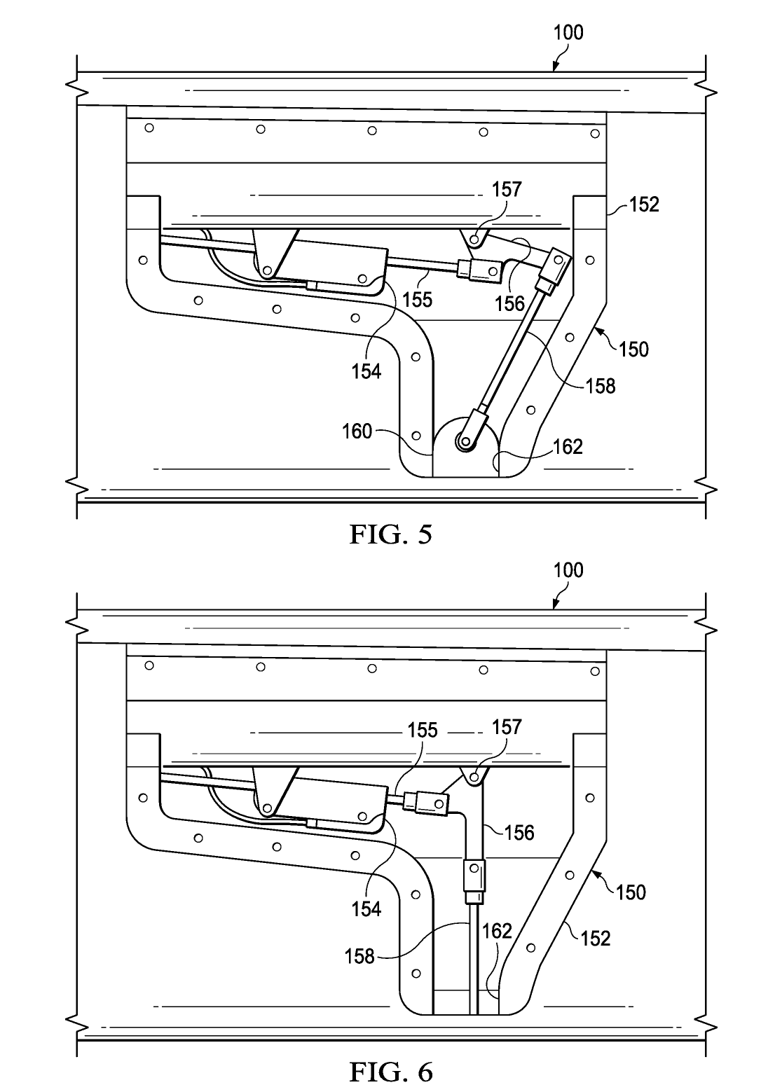

Referring now to FIGS. 5 and 6, detailed top views of actuator system 150 are shown in stowed and deployed positions, respectively, according to an embodiment of the disclosure. In operation, actuator shaft 155 of actuator 154 applies a force to lever 156 to rotate lever 156 about pivot point 157, and this motion drives link 158 to transfer the force applied by actuator 154 to tab tongue 160 secured to tab 116, thereby selectively moving tab 116 relative to trailing edge 104. Thus, linear motion of actuator shaft 155 of actuator 154 operates to selectively deploy and/or retract tab 116 between the stowed position and the deployed position.

It will be appreciated that the linear motion of actuator shaft 155 of actuator 154 may be in a different direction than the linear direction of deployment of tab 116 due to the configuration of lever 156. Thus, in some embodiments, the linear motion of actuator shaft 155 of actuator 154 may form a substantially obtuse angle with the linear direction of deployment of tab 116. However, in some embodiments, the linear motion of actuator shaft 155 of actuator 154 may be substantially perpendicular to the linear direction of deployment of tab 116. As shown, actuator shaft 155 may be extended by actuator 154 to retract tab 116 to the stowed position, while actuator shaft 155 may be retracted by actuator 154 to deploy tab 116 to the deployed position. However, in alternative embodiments, these relationships may be reversed.

Actuator system 150 may generally be configured to provide a default of the stowed position. This may also operate as a failsafe to prevent degradation of performance in airplane mode, since a majority of the flight time of a tiltrotor aircraft may be spent in airplane mode as compared to helicopter mode. Thus, malfunction of any component of actuator system 150 preferably causes tab 116 to automatically retract to the stowed position upon detection of a fault, even when the aircraft is operated in helicopter mode. This may be accomplished through commanded operation of actuator systems 150 that remain operable and/or through passive operation due to centrifugal force acting on actuator shaft 155, lever 156, and drive link 158. The configuration of these components and their angular positions and inboard positions relative to pivot point 157 when tab 116 is deployed cooperate to provide for passive operation through centrifugal force acting to translate and/or rotate the components to outboard positions, thereby moving tab 116 to the stowed position. Furthermore, deployment and/or retraction of tab 116 by actuator system 150 may be automated based on the flight mode of the aircraft. However, the aircraft may enable an override and/or manual adjustment, such that actuator system 150 may also operate to configure tab 116 in intermediate (e.g. partially deployed) positions between the stowed position and the deployed position to provide optimum lift, drag, and/or other flight performance characteristics in response to environmental conditions such as air density, temperature, humidity, precipitation, headwind, tailwind, crosswinds, other turbulence caused by weather conditions, and/or other environmental conditions or when transitioning between the stowed and deployed positions.

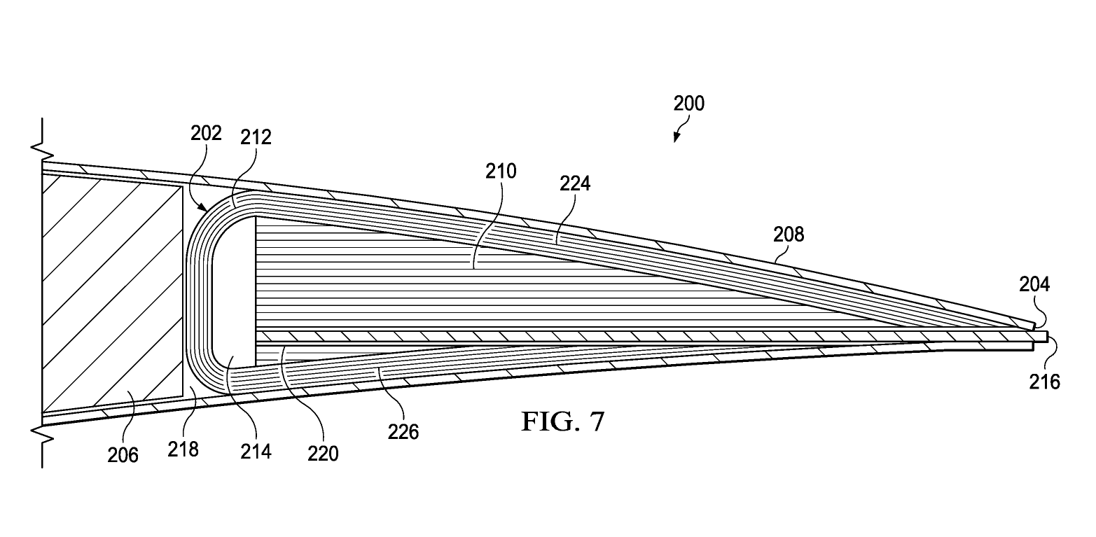

FIGS. 7 through 9 illustrate components of another embodiment of a rotor blade 200 according to this disclosure. FIG. 7 is a partial side cross-sectional view of a trailing edge of blade 200 (taken along a line similar to cutting line 3-3 of FIG. 2A) and comprises a trailing-edge wedge 202 positioned between trailing edge 204 and spar 206 for forming afterbody 208. In the embodiment shown, wedge 202 is formed from flat stack 210 of composite plies enclosed within a folded stack 212 of composite plies. A filler material, such as foam 214, may be used to achieve the desired shape of wedge 202 when folding plies of folded stack 212 around flat stack 210, such as for achieving desired stiffness of wedge 202 and for reducing stress concentrations at the folds. Foam 214, or a similar lightweight filler material, may also be used in voids such as void 218. A deployable tab 216, similar in construction and operation to tab 116 (as described above), is received within a tab channel 220, which is a slot preferably milled into wedge 202 after lay-up and curing of stacks 210, 212. In addition, slots are milled in wedge 202 for tab tongues (not shown) of tab 216 to extend out of wedge 202 and into composite tubs (not shown) in blade 200 housing actuators, as shown and described above for blade 100.

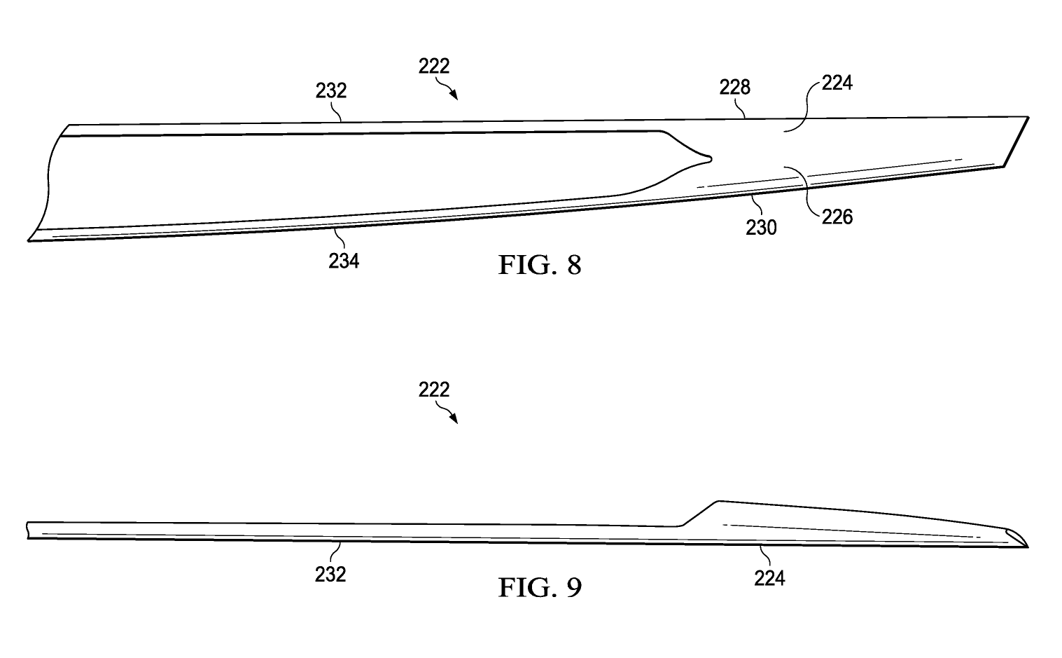

FIG. 8 illustrates a flat pattern of a ply 222 for folded stack 212. Ply 222 comprises an upper layer 224 and a bottom layer 226, each layer 224, 226 having a trailing edge 228, 230, respectively. Each layer 224, 226 has an elongate portion 232, 234 extending inboard for forming the trailing edge of rotor blade 200. FIG. 9 is a top view showing ply 222 folded as used in wedge 202.

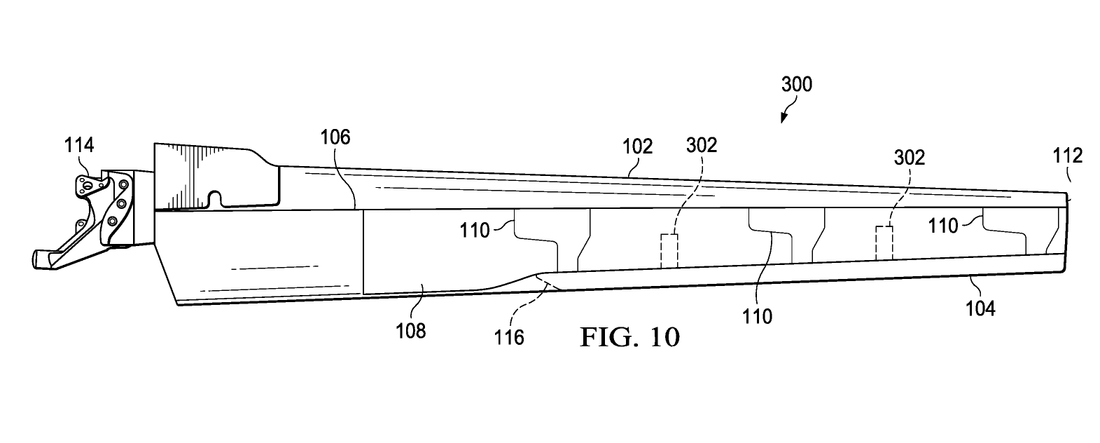

Referring now to FIG. 10, an orthogonal top view of an aircraft blade 300 is shown according to another embodiment of the disclosure. Blade 300 may be substantially similar to blade 100, as shown and described above. However, blade 300 comprises a plurality of supports 302. In some embodiments, supports 302 may generally be formed from a composite material and be integrally formed with tab 116. However, in other embodiments, supports 302 may be formed from aluminum, titanium, and/or any other high strength-to-weight material and be secured, attached, fastened, bonded and/or otherwise coupled to tab 116. Supports 302 may be similar to tab tongues 160 and configured to complement tab tongues 160 to provide additional support to tab 116 without being connected to an actuator system 150. Supports 302 will extend forward from tab 116 and through slots, which are preferably milled into a portion of afterbody 108 and/or spar 106 (not shown). Supports 302 may generally comprise at least one of a curved and/or chamfered profile that may increase the bending stiffness of tab 116. Further, supports 302 are preferably designed to maintain the predetermined pitch of tab 116 when tab 116 is in the deployed position while allowing for flexing together with blade 300 during flapping of blade 300. It will be appreciated that while two supports 302 are shown, any number of supports 302 may be employed depending on the application, size, weight, and/or other characteristics of blade 300.

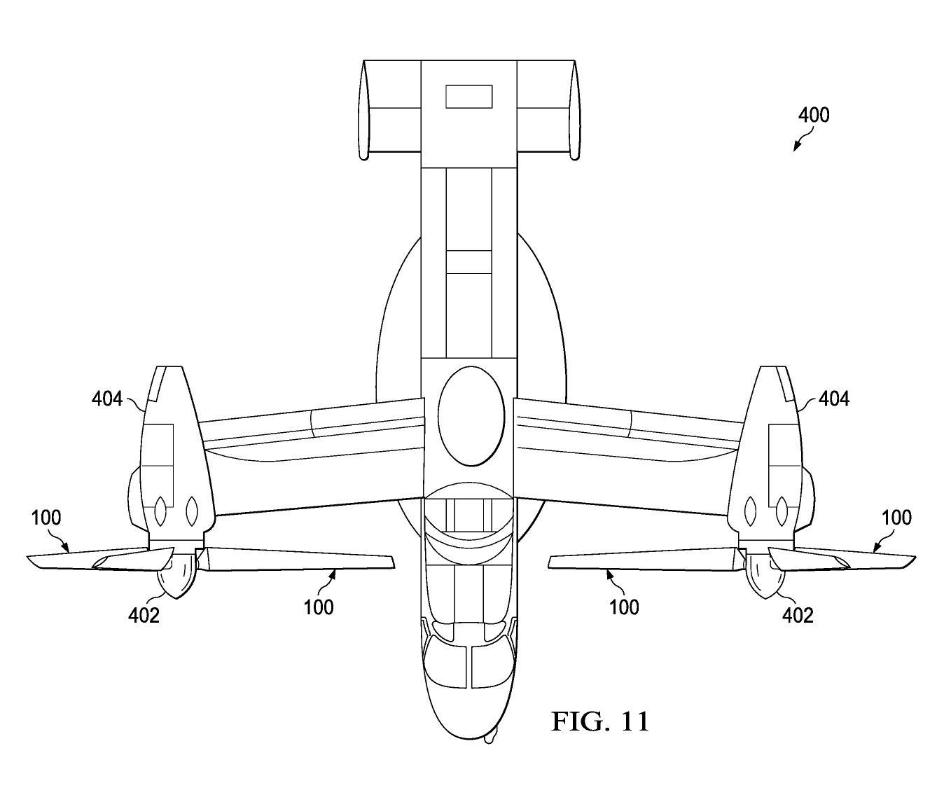

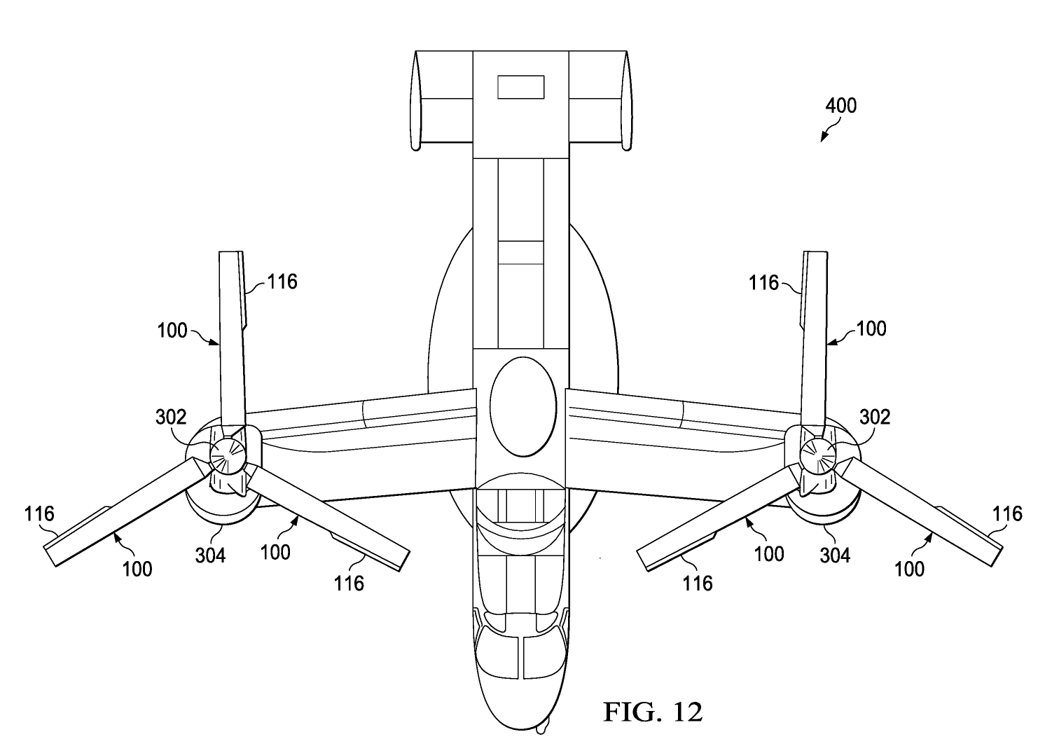

Referring now to FIGS. 11 and 12, top views of a tiltrotor aircraft 400 configured for operation in airplane mode and helicopter mode, respectively, are shown according to an embodiment of the disclosure. Aircraft 400 generally comprises a plurality of aircraft blades 100 (or 200 or 300) of a plurality of rotors 402, with each rotor 402 associated with one of a plurality of rotatable nacelles 404. It will be appreciated that while three aircraft blades 100 per rotor 402 are shown, aircraft 400 may comprise any number of blades 100 (e.g. 2, 3, 4, 5, 6, etc.) per rotor 402. Additionally, while only two nacelles 404 are shown, aircraft 400 may comprise any number of nacelles 404 (e.g. 2, 3, 4, 5, 6, etc.). While blades 100 are shown in use with a tiltrotor aircraft 400, blades 100 may be employed in various types of aircraft, including, but not limited to, fixed wing airplanes, helicopters, stop-fold tiltrotor aircraft, quad-tiltrotor aircraft, and/or any other comprising bladed rotor.

In operation, nacelles 404 may be rotated forward and/or backward to adjust the thrust angle of rotors 402. By adjusting the thrust angle, tiltrotor aircraft 400 may transition the mode of operation of aircraft 400 between wing-borne flight of airplane mode and rotor-borne flight of helicopter mode. It will be appreciated that airplane mode is associated with a more horizontally-oriented thrust angle, while helicopter mode is associated with a more vertically-oriented thrust angle. Therefore, to adjust the thrust angle from more horizontal to more vertical and transition from airplane mode to helicopter mode, nacelles 404 may be rotated backward. To adjust the thrust angle from more vertical to more horizontal and transition from helicopter mode to airplane mode, nacelles 404 may be rotated forward.

Additionally, aircraft 400 is configured to adjust chord length 118 of blades 100 to optimize aircraft performance in each flight mode. The airplane mode depicted in FIG. 11 is generally associated with propelling the aircraft forward and a more horizontally-oriented thrust angle. Accordingly, to reduce drag across blades 100, the shorter chord length 118′ is desired. Thus, tabs 116 of blades 100 are configured in the stowed position when aircraft 400 is operated in airplane mode. Additionally, tabs 116 may be gradually retracted while aircraft 400 is transitioning to airplane mode with nacelles 404 rotating forward, thereby gradually decreasing chord length 118 to the shorter chord length 118′. Selective gradual movement of tabs 116 may prevent abrupt changes in operational and/or performance characteristics of tiltrotor aircraft 400.

The helicopter mode depicted in FIG. 12 is generally associated with hovering and/or ascending from/descending to a landing area and a more vertically-oriented thrust angle. Accordingly, to increase the hover capacity of tiltrotor aircraft 400, the longer chord length 118″ is desired. Thus, tabs 116 of blades 100 are configured in the deployed position when aircraft 400 is operated in helicopter mode. Additionally, tabs 116 may be gradually deployed while aircraft 400 is transitioning to helicopter mode with nacelles 404 rotating backward, thereby gradually increasing chord length 118 to the longer chord length 118″. Additionally, tabs 116 may be gradually retracted when aircraft 400 is transitioning to airplane mode with nacelles 404 rotating forward to gradually decrease chord length 118 to the shorter chord length 118′ to reduce drag across blades 100 when aircraft 400 is operated in airplane mode. Selective gradual movement of tabs 116 may prevent abrupt changes in operational and/or performance characteristics of tiltrotor aircraft 400.

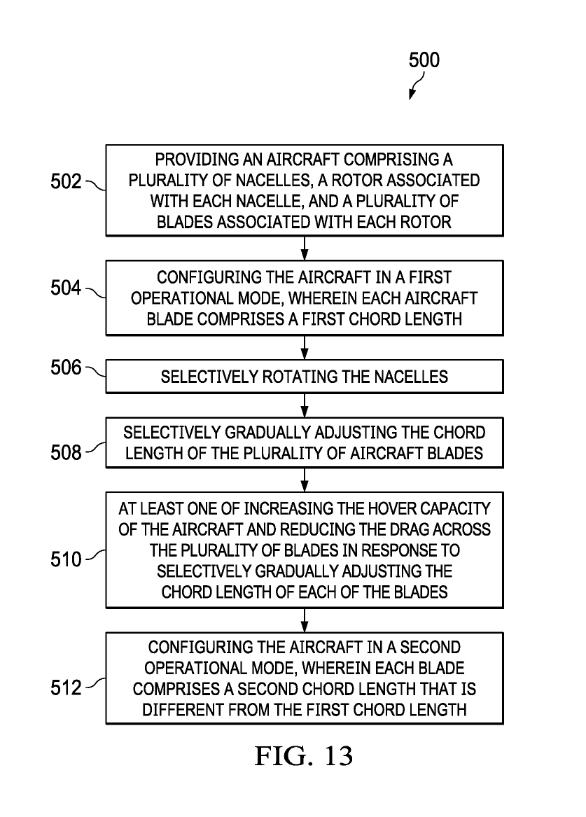

Referring now to FIG. 13, a flowchart of a method 500 of operating an aircraft is shown according to an embodiment of the disclosure. Method 500 may begin at block 502 by providing an aircraft 400 comprising a plurality of nacelles 404, a rotor 402 associated with each nacelle 404, and a plurality of aircraft blades 100 associated with each rotor 402. Method 500 may continue at block 504 by configuring aircraft 400 in a first operational mode, wherein each of aircraft blades 100 comprises a first chord length 118. The operational mode may generally comprise at least one of a stowed mode, wherein aircraft blades 100 comprise a shorter chord length 118′, and a deployed mode, wherein aircraft blades 100 comprise a longer chord length 118″. Method 500 may continue at block 506 by selectively rotating nacelles 404. Method 500 may continue at block 508 by selectively gradually adjusting chord length 118 of each of blades 100. Method 500 may continue at block 510 by at least one of increasing the hover capacity of aircraft 400 and reducing the drag across the plurality of blades 100 in response to selectively gradually adjusting chord length 118 of the plurality of blades 100. Method 500 may conclude at block 512 by configuring aircraft 400 in a second operational mode, wherein each of blades 100 comprises a second chord length 118 that is different from the first chord length 118. When the first operation mode comprises airplane mode, the second mode comprises helicopter mode. When the first operation mode comprises helicopter mode, the second operational mode comprises airplane mode.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A blade for an aircraft rotor, the blade comprising:
a trailing-edge tab, the tab being movable between a stowed position, in which substantially all of the tab is located within the blade, and a deployed position, in which at least a portion of the tab extends from a trailing edge of the blade; and
at least one actuator system selectively operable to cause movement of the tab between the stowed position and the deployed position;
wherein movement of the tab changes a chord length of the blade.

2. The blade of claim 1, wherein each actuator system comprises an electromagnetic linear actuator.

3. The blade of claim 2, wherein a direction of movement of each electromagnetic linear actuator is different from a direction of movement of the tab.

4. The blade of claim 1, wherein each actuator system comprises a tub carried by the blade for housing movable components of the associated actuator system.

5. The blade of claim 4, wherein each tub is secured to a spar of the blade.

6. The blade of claim 4, wherein each tub is secured to an afterbody of the blade.

7. The blade of claim 4, wherein the tab comprises a plurality of tab tongues, each tab tongue being configured to linearly slide within at least one of an associated guide disposed in each of the plurality of tubs and the afterbody of the blade.

8. The blade of claim 1, further comprising:
a plurality of supports extending from the tab and configured to engage the blade.

9. The blade of claim 1, wherein the tab is concealed within a footprint of the aircraft blade as the aircraft blade is viewed from a top plan view when the tab is retracted.

10. An aircraft, comprising:
at least one rotor, each rotor comprising a plurality of blades, comprising:
a trailing edge; and
a tab selectively received within a tab channel disposed in the trailing edge, wherein the tab is selectively linearly deployable therefrom to adjust a chord length of the blade.

11. The aircraft of claim 10, further comprising:
a nacelle associated with each rotor, each nacelle being selectively rotatable for changing a direction of a thrust vector of the associated rotor.

12. The aircraft of claim 11, wherein the aircraft is operable in an airplane mode and a helicopter mode.

13. The aircraft of claim 12, wherein the tabs are configured in a stowed position when the aircraft is operated in the airplane mode, and wherein the tabs are configured in a deployed position when the aircraft is operated in the helicopter mode to increase the chord length of each of the aircraft blades.

14. The aircraft of claim 13, wherein the aircraft selectively transitions from the airplane mode to the helicopter mode by selectively rotating each nacelle and selectively linearly deploying the tabs of each of the plurality of aircraft blades to increase the chord length of each of the plurality of blades.

15. The aircraft of claim 13, wherein the aircraft selectively transitions from the helicopter mode to the airplane mode by selectively rotating each nacelle and selectively linearly retracting the tabs of each of the plurality of aircraft blades to decrease the chord length of each of the plurality of aircraft blades.

16. A method of operating an aircraft, comprising:
providing an aircraft comprising a plurality of nacelles, a rotor associated with each nacelle, and a plurality of blades associated with each rotor, wherein each of the plurality of blades comprises a trailing edge and a tab selectively received within a tab channel disposed in the trailing edge, wherein the tab is selectively linearly deployable therefrom to adjust a chord length of the aircraft blades;
operating the aircraft in a first operational mode, wherein the plurality of aircraft blades comprises a first chord length;
selectively rotating the nacelles to transition from the first operational mode to a second operational mode, wherein the plurality of aircraft blades comprises a second chord length that is different from the first chord length; and
at least one of increasing the hover capacity of the aircraft and reducing the drag across the plurality of blades in response to selectively gradually adjusting the chord length of the plurality of blades in response to transitioning from the first operational mode to the second operational mode.

17. The method of claim 16, wherein the first operational mode comprises a helicopter mode, wherein the second mode comprises an airplane mode, and wherein the tabs of each of the plurality of blades are selectively linearly retracted as the plurality of nacelles are rotated forward.

18. The method of claim 16, wherein the first operational mode comprises an airplane mode, wherein the second mode comprises a helicopter mode, and wherein the tabs of each of the plurality of blades are selectively linearly deployed as the plurality of nacelles are rotated backward.
